(19) United States
(12) Patent Application Publication
(10) Pub. No.: US 2006/0033752 A1
(43) Pub. Date: Feb. 16, 2006

(54) Method and apparatus for displaying pixel data

(76) Inventors: David T. Gering, Waukesha, WI (US); John D. Hoford, Pewaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/917,622

(22) Filed: Aug. 13, 2004

(51) Int. Cl. G09G 5/00

(52) U.S. Cl. 345/629

(57) ABSTRACT

A method for displaying an image including a plurality of pixels includes defining a plurality of pixel groups for the image. Each pixel group includes at least one pixel. A pixel chart is generated for each pixel group. The pixel chart shows underlying data associated with the pixel group. The pixel chart is superimposed on the image over its associated pixel group. A system includes a display unit, a data collection unit adapted to collect underlying data, and a data processing unit. The data processing unit is adapted to generate an image including a plurality of pixels for displaying on the display unit based on the underlying data, define a plurality of pixel groups for the image, each pixel group including at least one pixel, generate a pixel chart for each pixel group, the pixel chart showing the underlying data associated with the pixel group, and superimpose the pixel chart on the image over its associated pixel group.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

Image archiving and communication systems have become an extremely important component in the management of digitized image data, particularly in the field of aerial imaging or medical imaging. Such systems often function as central repositories of image data, receiving the data from various sources. The image data is stored and made available to various individuals for viewing, analysis, or diagnosis.

Typically an image of a surface or volume is represented by pixels. Each pixel represents a spatial point or region. Data collected regarding the region is typically processed to generate a composite metric for the pixel region. The underlying data for the pixel may vary over time or frequency. For example, in a computed tomography (CT) system, intensity measurements are taken over a time interval and averaged to generate the composite metric. Each pixel is assigned a color based on its computed composite metric. In a aerial imaging system, a survey volume may be viewed using a plurality of frequencies. An average intensity value across the spectrum may be calculated for each pixel. Again, the color of the pixel is determined by the computed average.

The pixilated images provide useful visual data regarding the analysis volume. The color variations allow a viewer to efficiently discriminate between different regions of interest. However, in some cases the underlying time sequence or spectrum data is also important for analyzing a particular region. The pixelization of the data using the data using a composite metric may mask important data or provide a misleading measurement. For example, if the underlying data has widely varying values across time or frequency, the average statistic may not be informative. In a CT environment, intensity measurements are useful for distinguishing between living and dead tumor tissue. If cancerous tissue is still living, targeted radiation or chemical treatment may be conducted. However, in areas where the tissue is not living, no treatment is necessary. In some cases, the diagnosing viewer may wish to view the underlying time to confirm the status of the tissue before targeting further treatment.

Current viewing systems sometimes allow viewing of the underlying data on a display separate from the pixelized image. This arrangement adds cost and complexity because of the need for extra equipment. Also, ease of use is reduced as the user must transition between the two displays to see the pixel data versus the underlying data.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art.

### BRIEF SUMMARY OF THE INVENTION

One aspect of the present invention is seen in a method for displaying an image including a plurality of pixels. The method includes defining a plurality of pixel groups for the image. Each pixel group includes at least one pixel. A pixel chart is generated for each pixel group. The pixel chart shows underlying data associated with the pixel group. The pixel chart is superimposed on the image over its associated pixel group.

Another aspect of the present invention is seen in a system including a display unit, a data collection unit adapted to collect underlying data, and a data processing unit. The data processing unit is adapted to generate an image including a plurality of pixels for displaying on the display unit based on the underlying data, define a plurality of pixel groups for the image, each pixel group including at least one pixel, generate a pixel chart for each pixel group, the pixel chart showing the underlying data associated with the pixel group, and superimpose the pixel chart on the image over its associated pixel group.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a simplified block diagram of an imaging system in accordance with one aspect of the present invention; and

FIGS. 2-5 are diagrams illustrating exemplary pixel charts in the imaging system of FIG. 1.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

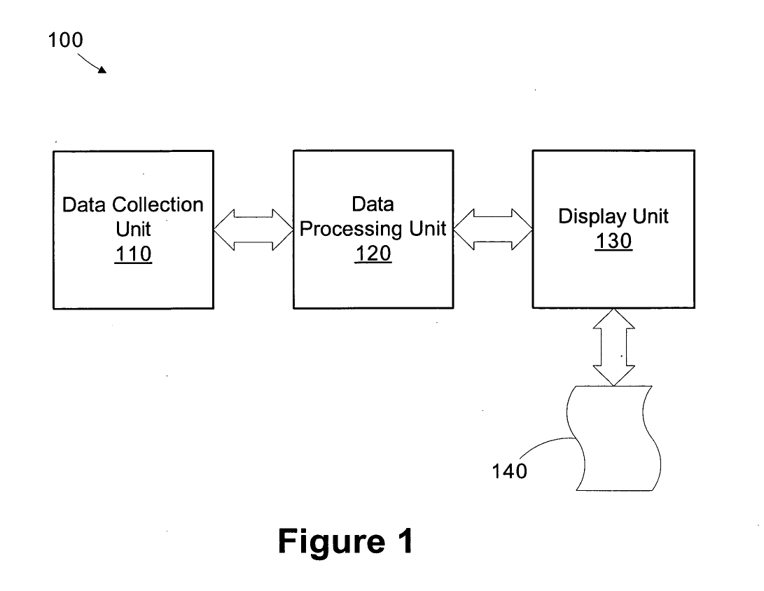

Referring now to FIG. 1, a simplified block diagram of an imaging system 100 in accordance with one aspect of the present invention is shown. The imaging system 100 includes a data collection unit 110, a data processing unit 120, and a display unit 130. The data collection unit 110 may have a variety of forms depending on the particular implementation. If the imaging system 100 is used for medical imaging the data collection unit 110 may be a computed tomography (CT) system or a nuclear magnetic resonance (NMR) imaging system. In the implementation where the imaging system 100 collects data such as geographical information, the data collection unit 110 may be a satellite, airborne platform, etc. The data processing unit 120 processes the data collected by the data collection unit 110 and generates a pixel chart image 140 for display on the display unit 130. The display unit may be a monitor, printer, etc. suitable for allowing a user to view the pixel chart image 140. The data processing unit 120 may be a general purpose computer, a specialized processing device, an application specific integrated circuit (ASIC), a digital signal processor (DSP) etc. In general, the data processing unit 120 computes a composite metric for the time or frequency data associated with each physical region represented by a pixel. The color or gray shade of the pixel is based on the value of the composite metric. For example, different intensity values in a CT image will appear as different colors or shades on the CT image. As will be described in greater detail below, the pixel chart image 140 also includes the underlying data used to generate the pixel superimposed thereon. Hence, the pixel shaded in accordance with the computed composite metric and the underlying data are shown simultaneously. As used herein, the terms color or shading may be used interchangeably.

Although the data collection unit 110, data processing unit 120, and display unit 130 are illustrated as separate entities, one or more of them may be integrated into a single unit. The data collection unit 110, data processing unit 120, and display unit 130 may be located remote from one another. In the case of an aerial imaging system, the data collection unit 110 may be housed on a satellite or airplane, and the data processing and display units 120, 130 may be located at a central facility. The data from the data collection unit 110 may be sent to the data processing unit 120 in real-time or near real-time, or alternatively, the data collection unit 110 may store the collected data for later communication with the data processing unit 120.

The application of the present invention is not limited to any particular imaging application or image type. The data used to generate the pixel chart image 140 may be time-varying or may vary across frequency. The composite metric may be generated from the underlying data using any number of mathematical or statistical techniques. A non-limiting list of exemplary composite characteristics may include a mean value, a median value, a maximum value, a minimum value, a variance value, a slope or other curve fit parameter, an intercept, a time constant, a value at a particular time in the time series, a value at a particular frequency in a spectrum, etc. Again, the invention may be applied to any particular form for the composite metric.

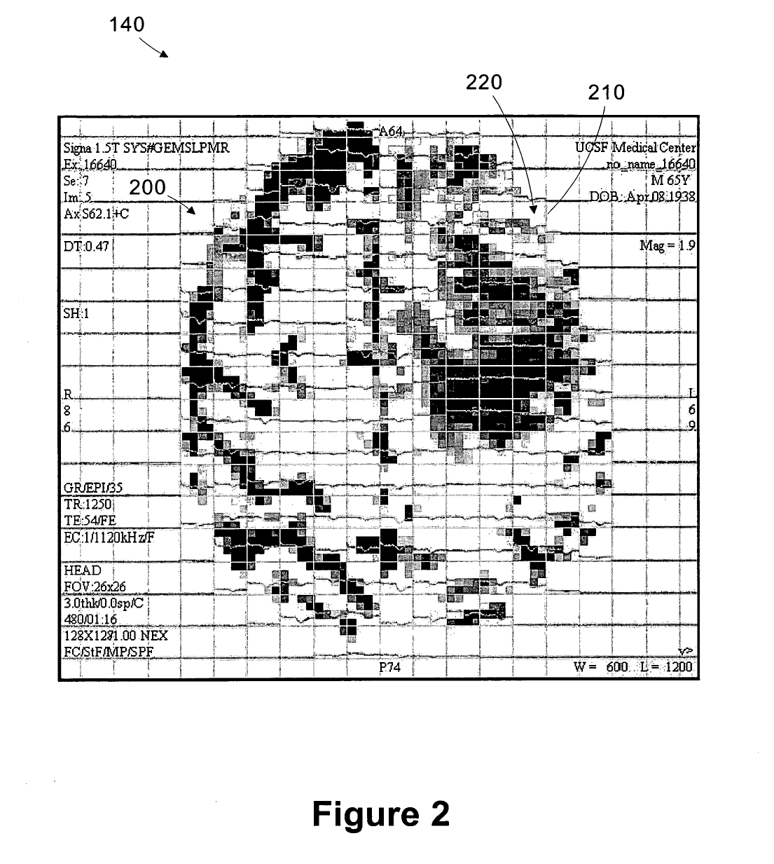

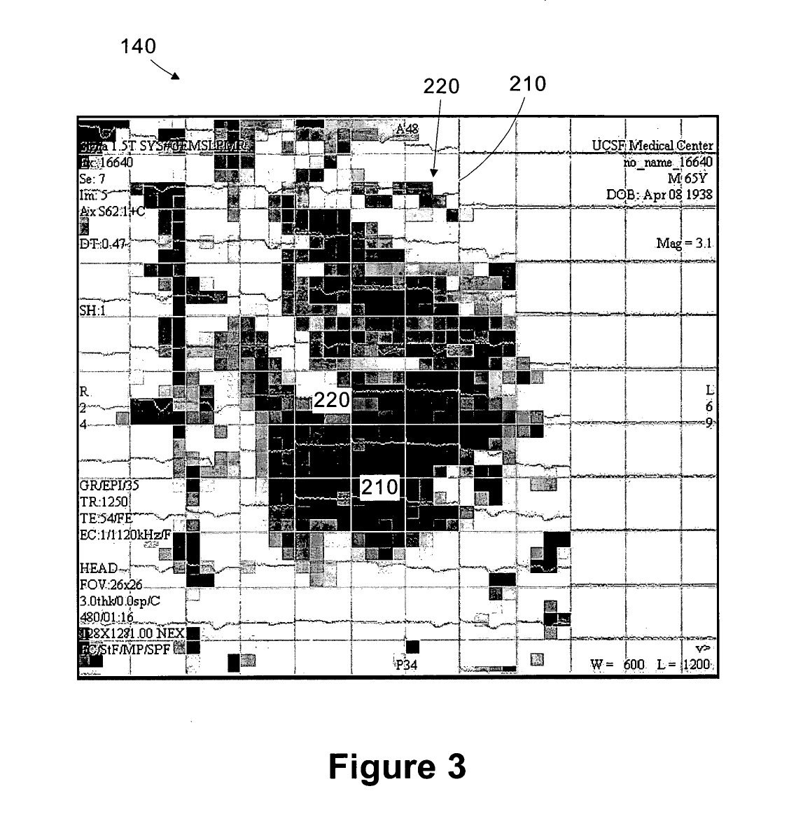

FIGS. 2-5 illustrate the pixel chart image 140 at various levels of zoom. The image shown in FIGS. 2-5 is of a CT brain scan where the composite metric used to generate the pixels represents average intensity over the time period of the scan. This particular image type and composite metric are selected for illustrative purposes only, as other image types may be used. FIG. 2 illustrates the pixel chart image 140 with no zoom. The pixel chart image 140 includes a plurality of pixels 200 and a plurality of charts 210 superimposed over one or more associated pixels, as seen by a pixel group 220. The granularity of the pixels will become more apparent in FIGS. 3-5 as the zoom level increases. In the embodiment shown in FIG. 2, each chart 210 is associated with the group 220 of pixels 200 encompassed by the borders of the chart 210. Each data point in the chart 210 represents a combined value for the intensity at a particular time point over all of the pixels 200 in the group 220. For example, the data for the pixels may be combined by averaging or smoothing followed by down sampling.

As the zoom levels increase, less pixels 200 may be included in each group 220 until such a point that each pixel 200 is individually discernable and has its own chart 210. In another embodiment, the charts 210 may not be visible until the user has zoomed in to a predetermined level. Again, pixel groups 220 may be formed and the chart 210 may represent combined values across the pixel group 220 or the pixel charts 210 may not be displayed until the individual pixels are discernible.

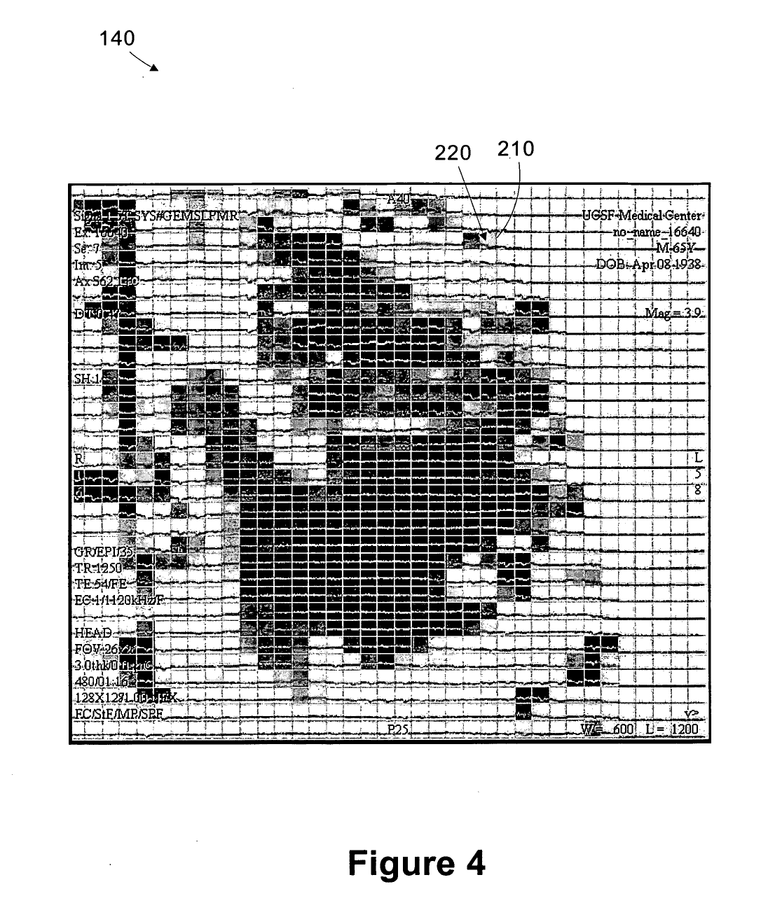

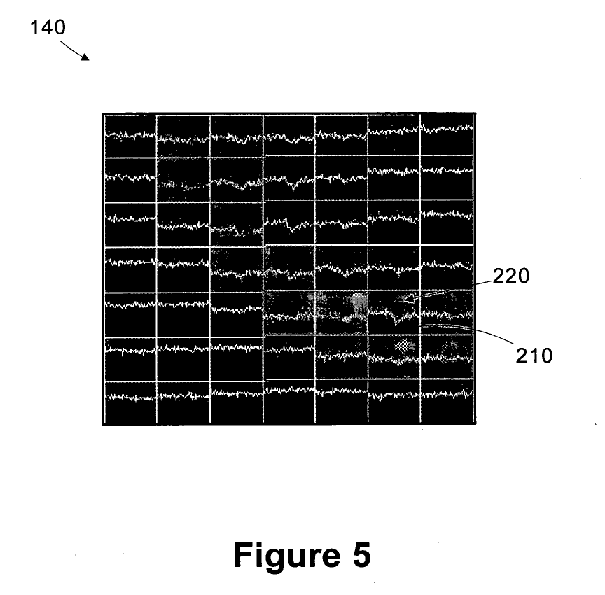

In FIG. 3, the zoom level has increased and a smaller portion of the pixel chart image 140 is visible. In FIG. 4, each group 220 includes only one pixel 200 and its associated chart 210. In FIG. 5, the pixel chart image 140 has been zoomed to such a level that each pixel 200 and its associated chart 210 are individually viewable. Of course, the zoom level could be further increased such that only one pixel 200 and its associated chart 210 is viewable.

The various zoom levels show different types of information. At the highest zoom level, the specific data for each pixel is viewable. This allows the user to evaluate the time series or spectrum used to generate the composite metric and thus the pixel color or shading. If the imaging system 100 is used for medical imaging, such as CT imaging, the pixel level zoom shown in FIG. 5 may be useful for verifying that cells in a tumor have been killed and need no further treatment. Likewise, cells still requiring further treatment may be identified and targeted. At lower zoom levels, such as in FIG. 3, the individual charts 210 may be readily viewed, but it has been found that the superimposition of the charts 210 over the pixel groups 220 affects the texture of the image as viewed by the user in manner not apparent in the raw pixelized image. The charts 210 in regions associated with dead cells appear relatively flat, while regions with active cells have more variation in the time series data. However, the average intensity of the cells in the active region may be sufficiently low that the colors of the pixels 200 may be similar to the colors of the pixels 200 in the dead regions. Hence, on the raw image, these regions may not be readily distinguishable. However, when the charts 210 are superimposed, those with flat features impart a first texture to the pixel chart image 140, while the charts 210 with varying intensities impart a different texture to the pixel chart image 140. Hence, the user can zoom in further in regions with a different texture to verify the features of the charts 210 in those regions.

The pixel chart image 140, as described herein, offers numerous advantages. A viewer may readily zoom and pan to different regions of the pixel chart image 140 and see the underlying data associated with the pixels 200 or pixel groups 220. The charts 210 provide both quantitative information by showing the underlying and qualitative information by altering the texture of the pixel chart image 140.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

I/we claim:

1. A method for displaying an image including a plurality of pixels, comprising:
defining a plurality of pixel groups for the image, each pixel group including at least one pixel;
generating a pixel chart for each pixel group, the pixel chart showing underlying data associated with the pixel group; and
superimposing the pixel chart on the image over its associated pixel group.

2. The method of claim 1, wherein each pixel has associated underlying data, and generating the pixel chart further comprises combining the underlying data for each pixel in the pixel group.

3. The method of claim 1, wherein defining the plurality of pixel groups further comprises defining each pixel group to include only one pixel.

4. The method of claim 1, wherein a plurality of zoom levels are provided for the image, and superimposing the pixel chart further comprises superimposing the pixel chart for zoom levels higher than a predetermined threshold.

5. The method of claim 1, further comprising:
calculating a composite metric for each pixel based on underlying data associated with each pixel; and
determining a color of the pixel based on the composite metric.

6. The method of claim 5, wherein determining the composite metric further comprises determining at least one of a mean value, a median value, a maximum value, a minimum value, a variance value, a slope, a curve fit parameter, an intercept, a time constant, a value at a particular time, and a value at a particular frequency.

7. The method of claim 1, wherein generating the pixel chart for each pixel group further comprises generating the pixel chart showing underlying time series data associated with the pixel group.

8. The method of claim 1, wherein generating the pixel chart for each pixel group further comprises generating the pixel chart showing underlying frequency spectrum data associated with the pixel group.

9. The method of claim 1, further comprising generating the image based on medical imaging data.

10. The method of claim 1, further comprising generating the image based on aerial imaging data.

11. A system, comprising:
a display unit;
a data collection unit adapted to collect underlying data;
a data processing unit adapted to generate an image including a plurality of pixels for displaying on the display unit based on the underlying data, define a plurality of pixel groups for the image, each pixel group including at least one pixel, generate a pixel chart for each pixel group, the pixel chart showing the underlying data associated with the pixel group, and superimpose the pixel chart on the image over its associated pixel group.

12. The system of claim 1, wherein each pixel has associated underlying data, and generating the pixel chart further comprises combining the underlying data for each pixel in the pixel group.

13. The system of claim 11, wherein each pixel group includes only one pixel.

14. The system of claim 11, wherein a plurality of zoom levels may be used for displaying the image, and the data processing unit is adapted to superimpose the pixel chart for zoom levels higher than a predetermined threshold.

15. The system of claim 11, wherein the data processing unit is further adapted to calculate a composite metric for each pixel based on underlying data associated with each pixel and determine a color of the pixel based on the composite metric.

16. The system of claim 15, wherein the composite metric comprises at least one of a mean value, a median value, a maximum value, a minimum value, a variance value, a slope, a curve fit parameter, an intercept, a time constant, a value at a particular time, and a value at a particular frequency.

17. The system of claim 11, wherein the underlying data comprises time series data associated with the pixel group.

18. The system of claim 11, wherein the underlying data comprises frequency spectrum data associated with the pixel group.

19. The system of claim 11, wherein the underlying data further comprises medical imaging data.

20. The system of claim 11, wherein the underlying data further comprises aerial imaging data.
